(19) United States
(12) Patent Application Publication
(10) Pub. No.: US 2007/0200910 A1
(43) Pub. Date: Aug. 30, 2007

(54) Electro-photographic devices incorporating ultra-small resonant structures

(75) Inventor: Jonathan Gorrell, Gainesville, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/418,085

(22) Filed: May 5, 2006

Related U.S. Application Data
(60) Provisional application No. 60/777,120, filed on Feb. 28, 2006.

(51) Int. Cl. B41J 2/45

(52) U.S. Cl. 347/238

(57) ABSTRACT

An imaging device includes an image carrier; and an array of ultra-small light-emitting resonant structures constructed and adapted to emit light onto the image carrier, at least one of said ultra-small light-emitting structures emitting light in response to exposure to a beam of charged particles. The image carrier may be a drum. One or more imaging devices may be incorporated in a copying machine; a printer; or facsimile machine.

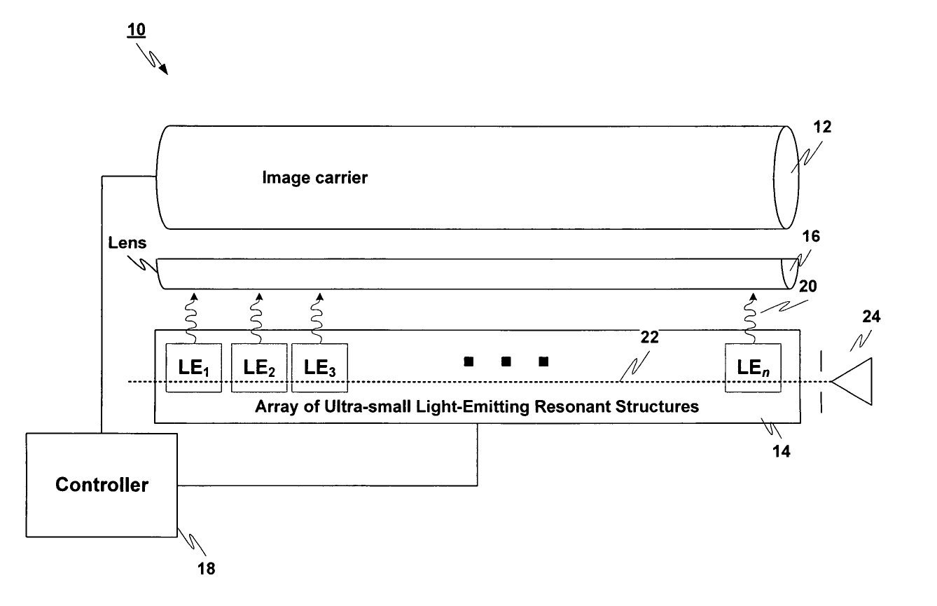

### CROSS-REFERENCE To RELATED APPLICATIONS

This application is related to and claims priority from the following co-pending U.S. patent application, the entire contents of which are incorporated herein by reference: U.S. Provisional Patent Application No. 60/777,120, titled “Systems and Methods of Utilizing Resonant Structures,” filed Feb. 28, 2006.

The present invention is related to the following co-pending U.S. patent applications which are all commonly owned with the present application, the entire contents of each of which are incorporated herein by reference:
1. U.S. application Ser. No. 11/302,471, entitled “Coupled Nano-Resonating Energy Emitting Structures,” filed Dec. 14, 2005,
2. U.S. application Ser. No. 11/349,963, entitled “Method And Structure For Coupling Two Microcircuits,” filed Feb. 9, 2006;
3. U.S. patent application Ser. No. 11/238,991, filed Sep. 30, 2005, entitled “Ultra-Small Resonating Charged Particle Beam Modulator”;
4. U.S. patent application Ser. No. 10/917,511 , filed on Aug. 13, 2004, entitled “Patterning Thin Metal Film by Dry Reactive Ion Etching”;
5. U.S. application Ser. No. 11/203,407, filed on Aug. 15, 2005, entitled “Method Of Patterning Ultra-Small Structures”;
6. U.S. application Ser. No. 11/243,476, filed on Oct. 5, 2005, entitled “Structures And Methods For Coupling Energy From An Electromagnetic Wave”;
7. U.S. application Ser. No. 11/243,477, filed on Oct. 5, 2005, entitled “Electron beam induced resonance,”
8. U.S. Application Ser. No. 11/325,448, entitled “Selectable Frequency Light Emitter from Single Metal Layer,” filed Jan. 5, 2006;
9. U.S. application Ser. No. 11/325,432, entitled, “Matrix Array Display,” filed Jan. 5, 2006,
10. U.S. patent application Ser. No. 11/400,280, titled “Resonant Detector for Optical Signals,” filed Apr. 10, 2006.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This relates to ultra-small light-emitting devices, and, more particularly, to using such devices in electro-photographic devices.

### INTRODUCTION

Conventional electro-photographic devices operate as follows: An electric charge is first applied to an image carrier (typically a revolving drum), for example, by a corona wire or a charge roller or the like. The image carrier (drum) has a surface of a special plastic or garnet. Light is written onto the image carrier using, e.g., a laser (with mirrors) or a liner array of light-emitting diodes (LEDs). In this manner, a latent image is formed on the drum's surface. The light causes the electrostatic charge to leak from the exposed parts of the image carrier. The surface of the image carrier passes through very fine particles of toner (e.g., dry plastic powder). The charged parts of the image carrier electrostatically attract the particles of toner. The drum then deposits the powder on a medium (e.g., a piece of paper), thereby transferring the image. The paper then passes through a mechanism (a fuser assembly), which provides heat and pressure to bond the toner to the medium.

The more specific aspects of electro-photographic devices are known to the artisan and for brevity will not be repeated herein.

The related applications describe various ultra-small resonant structures that emit electromagnetic radiation (EMR), in particular, light, when exposed to a beam of charged particles. The ultra-small structure(s) may comprise, for instance, any number of resonant microstructures constructed and adapted to produce EMR, e.g., as described above and/or in U.S. patent applications Ser. Nos. 11/325,448; 11/325,432; 11/243,476; 11/243,477; 11/302,471 (each described in greater detail above).

It is desirable to use such light-emitting ultra-small resonant devices in electro-photographic devices such as copying machines, printers, facsimile machines and the like.

### BRIEF DESCRIPTION OF THE DRAWINGS

The following description, given with respect to the attached drawing, may be better understood with reference to the non-limiting examples of the drawing, wherein the drawing shows an imaging device.

### THE PRESENTLY PREFERRED EXEMPLARY EMBODIMENTS

As shown in the drawing, an imaging device [symbol] includes an image carrier [symbol] and at least one array [symbol] of ultra-small light-emitting resonant structures (denoted [symbol] in the drawing). A lens system 16 may be disposed between the image carrier [symbol] and the array [symbol] . A controller [symbol] controls the image carrier [symbol] and the output of the array [symbol] .

Each of the light-emitting structures [symbol] may be any of the ultra-small light-emitting structures disclosed in the related applications. In general, the structures have physical dimensions that are, at least in part, smaller than the wavelength of the emitted light (usually, but not necessarily, several nanometers to several micrometers). For example, the array may comprise any number of light-emitters as described in U.S. application Ser. No. 11/325,448, or U.S. application Ser. No. 11/325,432. The various ultra-small devices may be made, e.g., using techniques such as described in U.S. patent applications Ser. Nos. 10/917,511; 11/203,407 (described in greater detail above), or in some other manner.

The ultra-small light-emitting resonant structures [symbol] may all be of the same type, or different structures may be used for different ones of the structures. The structures [symbol] , as described in the various related applications described above, emit light [symbol] when a charged particle beam from a source of charged particles passes near them. The source of charged particles may, for instance, be an electron beam [symbol] from a cathode [symbol] . The cathode [symbol] can be on the system [symbol] are apart from it, and can selectively induce any one, some, or all of the structures [symbol] . As noted in the related applications, the particle beam may comprise any charged particles (such as, e.g., positive ions, negative ions, electrons, and protons and the like) and the source of charged particles may be any desired source of charged particles such as an ion gun, a thermionic filament, tungsten filament, a cathode, a vacuum triode, a planar vacuum triode, an electron-impact ionizer, a laser ionizer, a field emission cathode, a chemical ionizer, a thermal ionizer, an ion-impact ionizer, an electron source from a scanning electron microscope, etc.

More than one array of ultra-small light-emitting resonant structures may be used, e.g., in order to render color images.

The ultra-small light-emitting resonant structures [symbol] may be formed at a density of 10,000 per inch.

In some preferred embodiments, the ultra-small light-emitting resonant structures [symbol] emit light at wavelengths shorter than 450 nm (blue to ultraviolet).

The imaging device [symbol] described above may be included in any imaging device, including, without limitation, a copying machine, a printer, a facsimile machine and the like.

All of the ultra-small resonant structures described are preferably under vacuum conditions during operation. Accordingly, in each of the exemplary embodiments described herein, the entire package which includes the ultra-small resonant structures may be vacuum packaged. Alternatively, the portion of the package containing at least the ultra-small resonant structure(s) should be vacuum packaged. Our invention does not require any particular kind of evacuation structure. Many known hermetic sealing techniques can be employed to ensure the vacuum condition remains during a reasonable lifespan of operation. We anticipate that the devices can be operated in a pressure up to atmospheric pressure if the mean free path of the electrons is longer than the device length at the operating pressure.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. An imaging device comprising:
an image carrier;
at least one source of charged particles; and
an array of ultra-small light-emitting resonant structures constructed and adapted to emit light onto the image carrier, at least one of said ultra-small light-emitting structures emitting light in response to exposure to a beam of charged particles.

2. A device as in claim 1 wherein the image carrier is a drum.

3. A device as in claim 1 wherein the ultra-small light-emitting resonant structures are each of the same type.

4. A device as in claim 1 wherein the ultra-small light-emitting resonant structures are formed at a density of more than 2500 per inch.

5. A device as in claim 1 wherein the ultra-small light-emitting resonant structures emit light at wavelengths shorter than 450 nm.

6. A device as in claim 1 wherein the source of charged particles is selected from the group comprising:
an ion gun, a thermionic filament, tungsten filament, a cathode, a vacuum triode, a planar vacuum triode, an electron-impact ionizer, a laser ionizer, a field emission cathode, a chemical ionizer, a thermal ionizer, and an ion-impact ionizer.

7. A device as in claim 1 wherein the charged particles are selected from the group comprising: positive ions, negative ions, electrons, and protons.

8. An electro-photographic device comprising:
an image carrier;
a source of charged particles;
an array of ultra-small light-emitting structures constructed and adapted to emit light onto the image carrier, at least one of said ultra-small light-emitting structures emitting light in response to exposure to a beam of charged particles; and
a controller constructed and adapted to control drawing of an image by said array onto said image carrier.

9. A device as in claim 8 wherein the device is incorporated in a machine selected from the group comprising: a copying machine; a printer; and a facsimile machine.

10. A device as in claim 9 further comprising:
a lens system disposed between the image carrier and the array.

11. A device as in claim 8 wherein the image carrier is a drum.

12. A device as in claim 8 wherein the ultra-small light-emitting resonant structures emit light at wavelengths shorter than 450 nm.

13. A device as in claim 8 wherein the source of charged particles is selected from the group comprising:
an ion gun, a thermionic filament, tungsten filament, a cathode, a vacuum triode, a planar vacuum triode, an electron-impact ionizer, a laser ionizer, a field emission cathode, a chemical ionizer, a thermal ionizer, and an ion-impact ionizer.

14. A device as in claim 8 wherein the charged particles are selected from the group comprising: positive ions, negative ions, electrons, and protons.

15. An electro-photographic device comprising:
one or more imaging devices, each said imaging device comprising:
(a) an image carrier; and
(b) an array of ultra-small light-emitting resonant structures constructed and adapted to emit light onto the image carrier, at least one of said ultra-small light-emitting structures emitting light in response to exposure to a beam of charged particles.

16. An electro-photographic device as in claim 15 wherein at least one of said one or more imaging devices further comprises a source of charged particles.

17. An electro-photographic device as in claim 15 wherein each of said one or more imaging devices further comprises a source of charged particles.

18. An electro-photographic device as in claim 15 wherein the image carrier is a drum.

19. An electro-photographic device as in claim 15 wherein, for at least one of the one or more imaging devices, the ultra-small light-emitting resonant structures are each of the same type.

20. An electro-photographic device as in claim 15 wherein the ultra-small light-emitting resonant structures are each of the same type.

21. An electro-photographic device as in claim 15 wherein at least some of the ultra-small light-emitting resonant structures are formed at a density of greater than 2500 per inch.

22. An electro-photographic device as in claim 15 wherein at least some of the ultra-small light-emitting resonant structures emit light at wavelengths shorter than 450 nm.

23. An electro-photographic device as in claim 15 comprising at least three imaging devices.

24. An electro-photographic device as in claim 23 wherein said at least three imaging devices is constructed and adapted to produce light corresponding to a different image color.

25. An electro-photographic device as in any one of claims 15-24 wherein said device is selected from the group comprising: a copying machine; a printer; and a facsimile machine.

26. An electro-photographic device as in any one of claims 15-24 wherein said image carrier is a drum.
